(19) United States
(12) Patent Application Publication
(10) Pub. No.: US 2026/0051752 A1
(43) Pub. Date: Feb. 19, 2026

(54) INTEGRATED LOW VOLTAGE DC-DC CONVERTER WITH ACTIVE BATTERY BALANCING BETWEEN MODULES AND BATTERY BALANCING METHOD USING THEREOF

(71) Applicant: Defense Agency for Technology and Quality, Jinju-si (KR)

(72) Inventor: Kyung-Hwa PARK, Daegu (KR)

(73) Assignee: Defense Agency for Technology and Quality, Jinju-si (KR)

(21) Appl. No.: 18/882,151

(22) Filed: Sep. 11, 2024

(30) Foreign Application Priority Data
Aug. 16, 2024 (KR) 10-2024-0109689

(51) Int. Cl. H02J 7/00; H02M 3/335

(52) U.S. Cl. CPC H02J 7/0019; H02J 7/007182; H02M 3/33573; H02J 2207/20

(57) ABSTRACT

According to an embodiment of the present disclosure, a power conversion device included in a power system may include a conversion circuit configured to transform a direct current (DC) voltage output from batteries, and a balancing circuit connected to a primary side of the conversion circuit and configured to balance states of charge of the batteries, the balancing circuit may perform driving so that a balancing target battery among the batteries is charged or discharged based on a gate signal for the conversion circuit, and the balancing target battery may be connected to the balancing circuit based on an average voltage of the batteries.

### CROSS-REFERENCE TO RELATED APPLICATION

This application claims priority under 35 U.S.C. § 119 to Korean Patent Application No. 10-2024-0109689, filed on Aug. 16, 2024, in the Korean Intellectual Property Office (KIPO), the disclosure of which is incorporated by reference herein in its entirety.

### TECHNICAL FIELD

The present disclosure relates to a direct current to direct current (DC-DC) converter, and more particularly, to a low voltage DC-DC converter including a circuit for equalizing states of charge of battery modules included in a battery pack, and a battery balancing method using the same.

### RELATED ART

As carbon emission regulations are strengthened worldwide, the use of lithium-ion (Li-ion) batteries is increasing. A communication power system currently in operation in a defense sector, a next-generation hybrid tank power system, a commercial electric vehicle, a communication system or an emergency power system that operates using commercial power in a defense or civilian sector, or the like converts an alternating current (AC) voltage into a DC voltage, stores the DC voltage in a high voltage battery, converts the DC voltage to a low voltage using DC-DC converter, stores it in a low voltage battery, and then transfers power stored in the low voltage battery to a load.

A high voltage battery is implemented to have a voltage level of about 400 V by connecting several Li-ion cells in series so that a lot of power can be stored even with a small ampere (Ah) capacity. Generally, since a voltage range of Li-ion cells is about 3.0 V to 4.2V, more than 100 cells must be connected in series to satisfy the voltage of a high voltage battery. Meanwhile, most high voltage batteries are configured of several modules for ease of management and replacement. Several lithium-ion cells are included in each module, and each module is individually equipped with a microcontroller for monitoring a voltage, temperature, module current, or the like of each lithium-ion cell, controlling cell balancing, and protecting the module, such as blocking in an emergency. Further, a master controller is built into the high voltage battery to control inter-module balancing and protect a system.

The most important factor to be considered at the time of use of a lithium-ion battery is stability. In a high voltage lithium-ion battery, an imbalance in impedance between modules occurs due to a difference in internal impedance between lithium-ion cells and an external temperature, and this imbalance becomes more severe over time. When charging/discharging continues in this state, a specific module may be charged above a maximum charging voltage and a dendrite may be formed on a lithium-ion cathode surface inside the cell. In this case, since the energy efficiency of a specific cell decreases, a voltage difference between the cells becomes more severe, and when this phenomenon continues and the dendrite grows in a separator, a short circuit is formed and, in the worst case scenario, an explosion and combustion can occur. Therefore, when the high voltage lithium-ion battery is applied to a power system, a balancing circuit for solving voltage imbalance between cells and/or modules is essential.

The balancing circuit operates to discharge cells (or modules) that are overcharged compared to an average voltage inside a battery module (or battery pack) or charge cells (or modules) that are overdischarged compared to the average voltage to adjust voltage of the cells (or modules) to an average voltage. This improves a state of charge (SoC) of each module to ultimately extend the life of the battery.

An operation scheme of the balancing circuit can be roughly divided into a passive scheme and an active scheme. The passive scheme is a scheme in which a voltage of a battery with a high SoC is bypassed and consumed through a resistor at the time of charging, while the active scheme is a scheme in which energy is transferred from a battery with a high SoC to a battery with a low SoC using active components (for example, a switch, an inductor, and a capacitor) during charging or discharging to maintain a balance. In the case of the passive scheme, a balancing speed is high, but heat generated during balancing increases an SoC difference between a balancing target cell (or module) and another cell (or module), causing additional balancing requirements. On the other hand, the active scheme takes a relatively long equalizing time compared to the passive scheme, but the life of the battery increases in a long term because an SoC distribution between cells or modules is made uniform without deterioration. Further, the active scheme is also efficient in terms of energy consumption because it is possible to circulate and use all the energy inside the battery without consuming the energy as heat.

In the case of a power system using a high voltage battery, a cell balancing circuit is included in each battery module, and an inter-module balancing circuit is included to equalize states of charge of the battery modules. The inter-module balancing circuit may include, for example, a flyback converter. Despite the rapid development of technologies, the flyback converter is used in many commercial systems for inter-module balancing due to simplicity and low cost of the flyback converter. However, a switch of the flyback converter has a large voltage stress caused by resonance between a leakage inductor and an output capacitor of the switch. Further, since the switch of the flyback converter is turned on by hard switching, the efficiency is low.

A bidirectional quasi-resonant flyback converter has the advantage of enabling the inter-module balancing at the time of charging and discharging and improving efficiency, but has the disadvantage of requiring additional elements for bidirectional implementation and requiring a complex control circuit to detect the lowest voltage of a switch.

Meanwhile, an auxiliary power module (APM)-based balancing topology has been proposed to perform SoC balancing of modules in a high voltage battery while converting a voltage level from a high voltage bus to a low voltage bus. In the case of the APM-based balancing topology, a small-capacity APM is connected to each module of the high voltage battery. Since a charge capacity of each APM varies depending on an SoC of the module to which the APM is connected, a power capacity of each APM must be overdesigned so that the APM can withstand worst system conditions. Therefore, the APM-based balancing topology has the disadvantage that the number of devices used is large and each APM connected in parallel to a low voltage bus must be individually controlled. Further, it is very difficult and complex to control current sharing mismatch of the low voltage bus due to an uneven impedance of each APM, an SoC of each module, a cell capacity, or the like. Therefore, a scheme capable of overcoming disadvantages of an existing balancing circuit is required.

### SUMMARY

A technical object of the present disclosure is to provide a DC-DC converter capable of converting an input voltage and balancing states of charge of batteries in both charging and discharging directions, and a battery balancing method using the same.

Another technical object of the present disclosure is to provide a DC-DC converter capable of an efficient energy operation even with simple control, and a battery balancing method using the same.

Technical objects to be achieved by the present disclosure are not limited to those described above, and other technical objects not mentioned above may also be clearly understood from the descriptions given below by those skilled in the art to which the present disclosure pertains.

According to an embodiment of the present disclosure, a power conversion device included in a power system may include a conversion circuit configured to transform a direct current (DC) voltage output from batteries, and a balancing circuit connected to a primary side of the conversion circuit and configured to balance states of charge of the batteries, the balancing circuit may perform driving so that a balancing target battery among the batteries is charged or discharged based on a gate signal for the conversion circuit, and the balancing target battery may be connected to the balancing circuit based on an average voltage of the batteries.

Here, the balancing circuit may include a transformer having preset turn ratio; switches driven based on the gate signal for the conversion circuit; and a DC blocking capacitor included between the switches and the transformer.

Further, the balancing circuit may include a phase shift full bridge, and the switches may be driven based on gate signals for lagging leg switches of the phase shift full bridge.

Further, the balancing circuit may charge the balancing target battery based on synchronization between a gate signal for a first switch among the switches and a gate signal for a first lagging leg switch of the phase shift full bridge, and the balancing circuit may discharge the balancing target battery based on synchronization between the gate signal for the first switch and a gate signal for a second lagging leg switch of the phase shift full bridge.

Further, the balancing circuit may charge the balancing target battery based on the number of batteries having a voltage lower than the average voltage among the batteries being equal to or smaller than a preset number.

Further, the balancing circuit may charge the balancing target battery based on the voltages of the batteries being within a preset voltage range.

Further, a gate signal applied to a first synchronous rectifier included in the secondary side of the conversion circuit and a gate signal applied to a second synchronous rectifier included in the secondary side of the conversion circuit may overlap during a preset period of time.

According to another embodiment of the present disclosure, a method of balancing states of charge of batteries in a controller of a power system may include monitoring voltages of the batteries and calculating an average voltage of the batteries based on the voltages of the batteries; selecting a balancing target battery among the batteries based on the average voltage of the batteries; and controlling a balancing circuit connected to a primary side of a conversion circuit so that the balancing target battery is charged or discharged, based on a gate signal for the conversion circuit configured to transform a direct current (DC) voltage output from the batteries.

According to yet another embodiment of the present disclosure, a power system may include a plurality of batteries; A DC-DC converter including a conversion circuit configured to transform a direct current (DC) voltage output from the plurality of batteries, and a balancing circuit connected to a primary side of the conversion circuit and configured to balance states of charge of the batteries; a switching circuit included between the batteries and the balancing circuit and configured to connect a balancing target battery among the batteries to the balancing circuit; and a controller configured to monitor the voltages of the batteries to calculate an average voltage of the batteries, control the switching circuit so that the balancing target battery is connected to the balancing circuit based on the average voltage, and control the balancing circuit so that the balancing target battery is charged or discharged based on a gate signal for the conversion circuit.

According to an embodiment of the present disclosure, it is possible to balance the states of charge of the batteries in both charging and discharging directions while converting an input voltage since the conversion circuit and the balancing circuit are integrated in the DC-DC converter.

According to an embodiment of the present disclosure, it is possible to implement the DC-DC converter capable of battery balancing by adding only a small number of components, and it is possible to improve energy efficiency even with low manufacturing costs since an additional powering operation is possible in the discharging mode.

According to an embodiment of the present disclosure, since the balancing circuit is controlled using the gate signal for the conversion circuit, the control is simple, and since zero voltage switching is possible at a full load, a switching loss can be reduced.

### BRIEF DESCRIPTION OF THE DRAWINGS

FIG. 1 is a diagram illustrating a power system according to an embodiment of the present disclosure.

FIG. 2 is a diagram illustrating a power conversion device according to an embodiment of the present disclosure.

FIG. 3 is a diagram illustrating gate signals in a discharging mode according to an embodiment of the present disclosure.

FIG. 4 is a diagram illustrating gate signals in a charging mode according to an embodiment of the present disclosure.

FIG. 5 is a diagram illustrating a voltage gain of the power conversion device according to the embodiment of the present disclosure.

FIG. 6 is a diagram illustrating a maximum duty depending on turn ratio of a transformer in a conversion circuit according to an embodiment of the present disclosure.

FIG. 7 is a diagram illustrating a scheme of applying a gate signal to synchronous rectifiers according to an embodiment of the present disclosure.

FIG. 8 is a diagram illustrating a battery balancing method according to an embodiment of the present disclosure.

### DETAILED DESCRIPTION OF EMBODIMENTS

The advantages and features of the present disclosure, and a method for achieving them will be clearly understood with reference to the embodiments described in detail together with appended drawings. However, the present disclosure is not limited to the embodiments disclosed below but may be implemented in various other forms; rather, the present embodiments are provided to make the present disclosure complete and inform those skilled in the art clearly of the technical scope of the present disclosure, and the present disclosure may be defined within the technical scope of the appended claims. Thus, in some embodiments, well-known processing steps, structures, and techniques have not been described in detail to avoid obscuring the interpretation of the present disclosure.

The terms used in the present disclosure have been selected from commonly used and widely accepted terms that best describe the functions of the present disclosure; however, it should be noted that the selection of terms may vary depending on the intention of those persons skilled in the corresponding field, precedents, or emergence of new technologies. Also, in a particular case, some terms may be selected arbitrarily by the applicant, and in this case, detailed definitions of the terms will be provided in the corresponding description of the present disclosure. Therefore, the terms used in the present disclosure should be defined not simply by their apparent name but based on their meaning and context throughout the present disclosure.

Throughout the document, unless otherwise explicitly stated, if a particular element is said to “include” some particular element, it means that the former may further include other particular elements rather than exclude them.

Also, the terms such as first, second, and third are introduced to describe various constituting elements, but the constituting elements should not be limited by the terms. The terms are used only for the purpose of distinguishing one from the other constituting elements.

In what follows, embodiments of the present disclosure will be described in detail with reference to appended drawings so that those skilled in the art to which the present disclosure belongs may readily apply the present disclosure. Moreover, to describe the present disclosure without ambiguity, those parts not related to the description of the present disclosure have been omitted. Throughout the document, the same reference symbols refer to the same constituting elements.

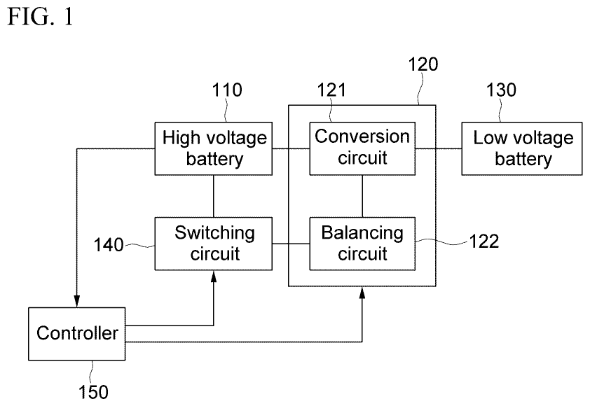

FIG. 1 is a diagram illustrating a power system according to an embodiment of the present disclosure.

Referring to FIG. 1, the power system according to an embodiment of the present disclosure may include a high voltage battery 110, a DC-DC converter 120, a low voltage battery 130, a switching circuit 140, and a controller 150.

The high voltage battery 110 may be implemented as a battery pack and may include a plurality of battery modules. Each battery module may include a plurality of lithium-ion cells. The high voltage battery 110 may be implemented to have a voltage range of about 400 V by connecting lithium-ion cells having a voltage range of about 3.0 to 4.2 V in series, for example. In the following description, the term ‘battery’ may simply refer to a battery module in the high voltage battery 110.

In the present disclosure, the DC-DC converter 120 may be used interchangeably with terms such as a low DC-DC converter (LDC) and a power conversion device. The DC-DC converter 120 may be included between the high voltage battery 110 and the low voltage battery 130. The DC-DC converter 120 may include a conversion circuit 121 configured to transform a DC voltage output from the batteries in the high voltage battery 110, and a balancing circuit 122 configured to balance states of charge of the batteries in the high voltage battery 110. Therefore, the DC-DC converter 120 may convert a high voltage input from the high voltage battery 110 into a low voltage and output the low voltage to the low voltage battery 130, and balance states of charge of the batteries in the high voltage battery 110 in a charging direction and/or in a discharging direction.

Specifically, the conversion circuit 121 may convert the high voltage output from the high voltage battery 110 into a low voltage (for example, about 14 V), and supply the low voltage to the low voltage battery 130. To this end, a phase shift full bridge (PSFB) may be included in the primary side of the conversion circuit 121, and synchronous rectifiers may be included in the secondary side.

The balancing circuit 122 may be connected to the primary side of the conversion circuit 121, such as a lagging leg of the PSFB. The balancing circuit 122 may include a transformer, at least two switches, and at least one DC blocking capacitor. The transformer may have preset turn ratio. The turn ratio of the transformer included in the balancing circuit 122 may be different from that of the transformer included in the conversion circuit 121. The switches in the balancing circuit 122 may be driven based on a gate signal for the conversion circuit 121. For example, the balancing circuit 122 may include a first switch and a second switch, and the first switch and the second switch may be driven exclusively based on a gate signal for lagging leg switches of the PSFB to charge and/or discharge a balancing target battery among the batteries in the high voltage battery 110. The balancing circuit 122 may be called an inter-module battery equalization circuit (IBEC) in that the balancing circuit 122 equalizes the states of charge of the battery modules in the high voltage battery 110.

The switching circuit 140 may be included between the high voltage battery 110 and the DC-DC converter 120, and may be configured to connect the balancing target battery among the batteries in the high voltage battery 110 to the balancing circuit 122.

The controller 150 may monitor the voltages of the batteries in the high voltage battery 110 to calculate an average voltage of the batteries in real time. To this end, the high voltage battery 110 may include sensors for detecting a voltage, temperature, current, and the like of the batteries. The controller 150 may be included inside the high voltage battery 110 as needed.

The controller 150 may determine or select a balancing target battery among the batteries in the high voltage battery 110 based on the average voltage of the batteries in the high voltage battery 110, and control the switching circuit 140 so that the balancing target battery is connected to the balancing circuit 122. Further, the controller 150 may control the balancing circuit 122 based on the gate signal for the conversion circuit 121 so that the balancing target battery is charged and/or discharged. For example, the controller 150 may charge or discharge the balancing target battery by controlling driving of the switches in the balancing circuit 122 based on a gate signal for the lagging leg switches of the PSFB.

The DC-DC converter 120 according to an embodiment of the present disclosure can basically operate in a discharging mode, and operates in a charging mode only when the number of batteries having a voltage lower than the average voltage in the high voltage battery 110 is equal to or smaller than a preset number, thereby quickly and efficiently equalizing the charge status of the batteries in the high voltage battery 110.

As an example, the controller 150 may calculate a difference between the average voltage of the batteries in the high voltage battery 110 and the voltage of each battery, and select the battery having the largest difference from the average voltage as the balancing target battery. When the number of batteries having the voltage lower than the average voltage in the high voltage battery 110 is larger than the preset number or the state of charge (or voltage) of the balancing target battery is higher than those of other batteries, the controller 150 may perform control so that a gate signal for the first switch (upper switch) of the balancing circuit 122 is synchronized with a gate signal for a second lagging leg switch (lower lagging leg switch) of the conversion circuit 121. In this case, a balancing current in the balancing circuit 122 can flow in a direction that the balancing target battery is discharged. That is, the DC-DC converter 120 can operate in the discharging mode.

However, when the number of batteries having the voltage lower than the average voltage in the high voltage battery 110 is equal to or smaller than the preset number and the state of charge (or voltage) of the balancing target battery is lower than those of the other batteries, the controller 150 may may perform control so that the gate signal for the first switch (upper switch) of the balancing circuit 122 is synchronized with a gate signal for a first lagging leg switch (upper lagging leg switch) of the conversion circuit 121. In this case, the balancing current in the balancing circuit 122 may flow in a direction in which the balancing target battery is charged. This operation may be called a charging mode in that the balancing target battery is charged.

Meanwhile, the DC-DC converter 120 according to the embodiment of the present disclosure may perform control so that a gate signal applied to a first synchronous rectifier included in the secondary side of the conversion circuit 121 and a gate signal applied to a second synchronous rectifier overlap during a preset period of time. In this case, since a primary-side current of the conversion circuit 121 is built up even under a small load condition, zero voltage switching (ZVS) of the switches in the conversion circuit 121 is possible, and thus, a switching loss can be reduced so that the energy efficiency of the DC-DC converter 120 can be improved.

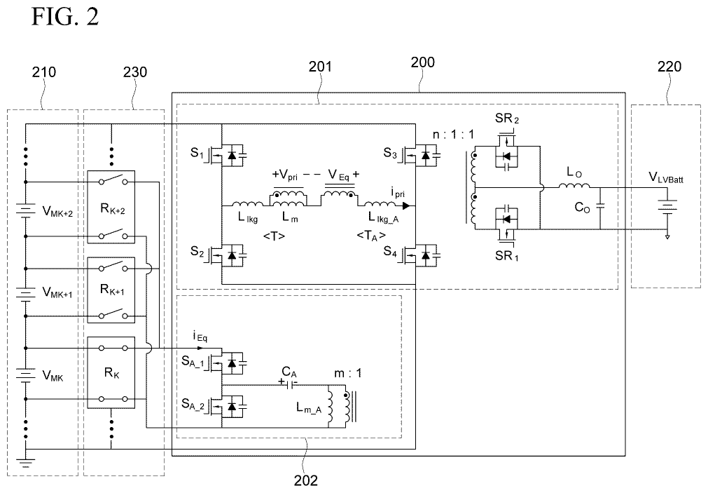

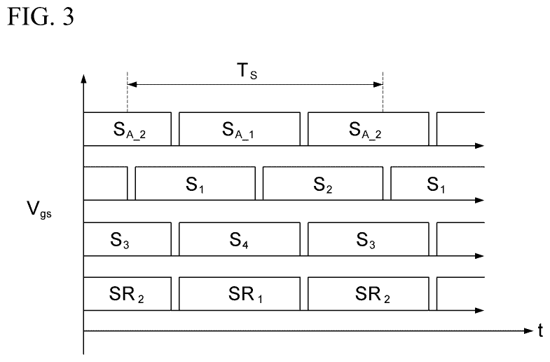

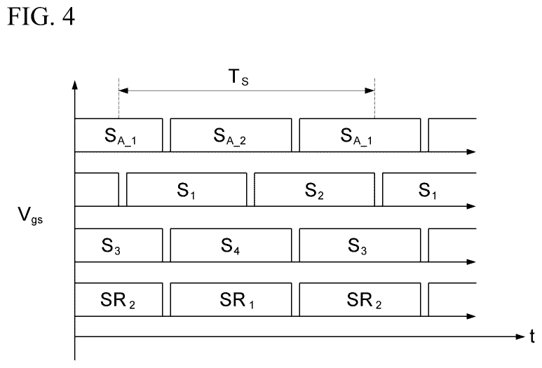

FIG. 2 is a diagram illustrating a power conversion device according to an embodiment of the present disclosure, FIG. 3 is a diagram illustrating gate signals in a discharging mode according to an embodiment of the present disclosure, and FIG. 4 is a diagram illustrating gate signals in a charging mode according to an embodiment of the present disclosure.

First, referring to FIG. 2, an input of a power conversion device 200 according to an embodiment of the present disclosure may be connected to a high voltage battery 210, and an output thereof may be connected to a low voltage battery 220. The power conversion device 200 may include a conversion circuit 201 and an IBEC 202. The conversion circuit 201 may be implemented as a PSFB converter. The IBEC 202 may be added between switch legs included in the primary side of the conversion circuit 201. The IBEC 202 may include a transformer, two switches, and a DC blocking capacitor, as illustrated in FIG. 2.

The high voltage battery 210 may include a plurality of battery modules MK+2, MK+1, MK . . . . A master controller (hereinafter referred to as a controller) of the power system (or battery management system) may monitor a voltage of each battery module. The controller may calculate an average voltage of the battery modules in the high voltage battery 210 based on the voltages of the respective battery modules. The controller may compare the average voltage with the voltage of each battery module and select the module having the largest difference as a battery balancing target module.

The high voltage battery 210 may be connected to the IBEC 202 by the switching circuit 230. The switching circuit 230 may include a plurality of switches R_{K+2}, R_{K+1}, R_{K} . . . . The switches in the switching circuit 230 may be implemented by relays, module switches, individual polarity metal oxide semiconductor field effect transistors (MOSFETs), or the like. The controller may turn on a switch for the balancing target module among the switches in the switching circuit 230 to connect the balancing target module to the IBEC 202 for inter-module balancing. When the balancing of the balancing target module is completed by the IBEC 202, the switching circuit 230 may be turned off and the balancing target module may be separated from the IBEC 202. Thereafter, the controller may update the average voltage of the battery modules. When a gap between the voltages of all the battery modules and the updated average voltage is within a pre-designed balancing start threshold, the inter-module balancing may not be performed. However, when there is another battery module having a larger voltage gap from the average voltage among the remaining battery modules, the inter-module balancing through the IBEC 202 may be performed again on such a battery module. This process is repeated, and the inter-module balancing may be completed when all the battery modules fall within the pre-designed balancing start threshold.

The switch of the IBEC 202 may operate based on a gate signal for a lagging leg switch of the conversion circuit 201. The IBEC 202 may equalize the SoC of the battery modules in the high voltage battery 210 in both directions, that is, in a discharging direction and/or a charging direction, depending on the gate signal applied to the switches in the IBEC 202. The low voltage battery 220 may be charged both when the high voltage battery 210 is discharged and when the high voltage battery 210 is charged.

For example, when SoC of a Kth module MK among the battery modules of the high voltage battery 210 is the highest, energy discharged from a balancing target module MK through the inter-module balancing is transferred to the low voltage battery 220. Since the power conversion device 200 charges the low voltage battery 220 through an PSFB operation, the energy discharged from the balancing target module MK also ultimately contributes to the charging of the low voltage battery. This operation may be called a discharging mode in that the operation discharges the balancing target module.

Meanwhile, when the SOC of the Kth module MK among the battery modules of the high voltage battery 210 is the lowest, the balancing target module MK is charged by the high voltage battery 210 via the IBEC 202 through the inter-module balancing, and at the same time, the low voltage battery 220 is charged through the conversion circuit 201. As a result, energy of the high voltage battery 210 is distributed to balance the balancing target module MK and charge the low voltage battery 220. This operation may be called a charging mode in that the balancing target module is charged.

Since the power conversion device 200 can operate in the discharging mode and the charging mode depending on the SoC of the balancing target module, the power conversion device 200 can perform balancing of the high voltage battery in a shorter time than a unidirectional balancing circuit.

The power conversion device 200 basically operates in the discharging mode, and may operate in the charging mode only when there are few unbalanced modules with the voltage lower than the average voltage. Through such mode management, several modules are charged so that the SoC of all the modules can be equalized in a shorter time.

Hereinafter, the discharging mode will be described in more detail with reference to FIGS. 2 and 3.

The discharging mode starts when commutation of the secondary-side synchronous rectifiers SR₁ and SR₂ ends in a state in which switches S₁ and S₄ of the conversion circuit 201 and a switch S_{A_1} of the IBEC 202 are turned on by a gate signal V_{gs}. In this case, the secondary-side synchronous rectifier SR₁ of the conversion circuit 201 is turned on in a forward bias state, and the energy of the high voltage battery 210 charges the low voltage battery 220. MK, which is the balancing target module, is also discharged to assist in charging the low voltage battery 220. Therefore, a primary-side voltage Vₚᵣᵢ of the conversion circuit 201 is equal to a voltage V_{HVBatt} of the high voltage battery+a primary-side voltage V_{Eq} of the IBEC transformer.

Thereafter, when the switch S₁ of the conversion circuit 201 is turned off, an output capacitor of a switch S₂ is discharged to 0 voltage due to a high output inductor current. Accordingly, when a voltage across a parasitic diode of the switch S₂ becomes substantially 0 voltage and a conduction state arrives, the switch S₂ is turned on under a ZVS condition. In this case, since the switches S_{A_1} and S₄ are still turned on, the secondary-side synchronous rectifier SR₁ is still in the forward bias state, and V_{Eq} is maintained.

When the switch S₁ is turned off and the switches S₂ and S₄ are turned on, the conversion circuit 201 supplies power differently from an existing PSFB converter because SR₁ is still turned on in the forward bias state.

When the switch S₄ and S_{A_1} are turned off, output capacitors of switches S₃, S₄, S_{A_1} and S_{A_2} resonate with a leakage inductor L_{lkg} of the conversion circuit 201 and a leakage inductor L_{lkg_A} of the IBEC 202 until the switches S₃ and S_{A_2} are turned on. As a result, the output capacitors of switches S₃ and S_{A_2} are discharged and the output capacitors of switches S₄ and S_{A_1} are charged.

While switches S₃ and S_{A_2} are turned on and the switch S₂ is turned on, the primary-side voltage of the conversion circuit 201 becomes substantially 0. Thereafter, when a current of the secondary-side synchronous rectifiers SR₁ and SR₂ becomes equal to an output inductor current, the commutation is terminated.

An operation of the power conversion device 200 after the switch S_{A_2} is turned on is symmetrically identical to the operation of the power conversion device 200 when the switch S_{A_1} is turned on.

Next, the charging mode will be described in more detail with reference to FIGS. 2 and 4.

The charging mode starts when the switch S_{A_2} of the IBEC 202 is turned on under the ZVS condition by the gate signal V_{gs}. When the switches S₁ and S₄ of the conversion circuit 201 and the switch S_{A_2} of the IBEC 202 are turned on, the primary-side voltage V_{Eq} of the IBEC transformer has a negative value. Therefore, the secondary-side synchronous rectifier SR₁ is turned on in a forward bias state, and the energy of the high voltage battery 210 charges the low voltage battery 220. At the same time, the balancing target module MK is also charged by the high voltage battery 210.

In a state in which the switches S₂ and S₄ of the conversion circuit 201 and the switch S_{A_2} of the IBEC 202 are turned on, the primary-side voltage of the conversion circuit 201 becomes substantially 0 like the existing PSFB converter, and the secondary-side synchronous rectifiers SR₁ and SR₂ freely rotate. Therefore, no power is supplied during this period. V_{Eq} is applied to the leakage inductor L_{lkg}+m²L_{lkg_A}, and the primary-side current decreases with a slope of V_{Eq}/(L_{lkg}+m²L_{lkg_A}). Here, m represents turn ratio of the IBEC transformer.

While the switches S₄ and S_{A_1} are turned off, the output capacitors of the switches S₃ and S₄ resonate with the leakage inductors L_{lkg} and L_{lkg_A}. Therefore, the output capacitor of the switch S₃ is discharged and the output capacitor of the switch S₄ is charged.

While the switch S₃ is turned on and the switches S₂ and S_{A_2} are turned on, the primary-side voltage of the conversion circuit 201 is substantially 0, and an input voltage is applied to the leakage inductances L_{lkg} and m²L_{lkg_A}. Therefore, the primary-side current decreases with a steep slope. When the current of the secondary-side synchronous rectifier reaches an output current, the commutation is completed.

When the switch S_{A_2} is turned off, the output capacitors of the switches S₁ and S₂ resonate with the leakage inductors L_{lkg} and L_{lkg_A}. Therefore, the output capacitor of the switch S₁ is discharged, and the output capacitor of the switch S₂ is charged. Since the switch S_{A_1} of the IBEC 202 is turned on with a negative current due to the delay of the gate signal, ZVS is naturally achieved.

In the charging mode, an operation of the power converter 200 after S_{A_1} is turned on is symmetrically identical to that of the power converter 200 in a state in which S_{A_2} is turned on.

Since the power conversion device 200 according to the embodiment of the present disclosure can charge the low voltage battery 220 through the conversion circuit 201 when the power conversion device 200 operates in the discharging mode, which is a main operation mode, using balancing energy as described above, an efficient energy operation is possible. Further, since a gate signal for the conversion circuit 202 is used for driving of the IBEC 202, the control is simple.

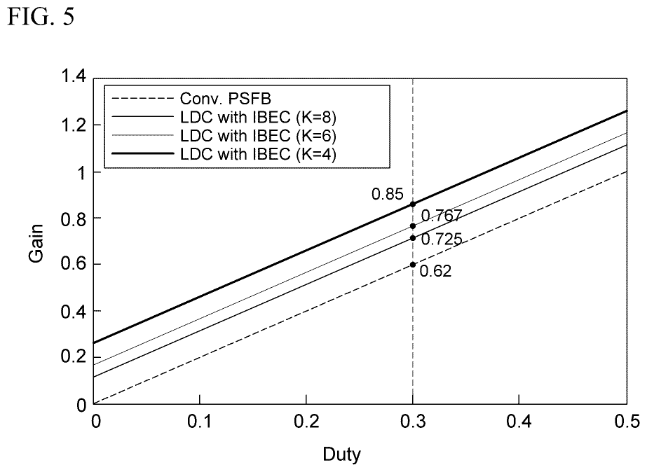

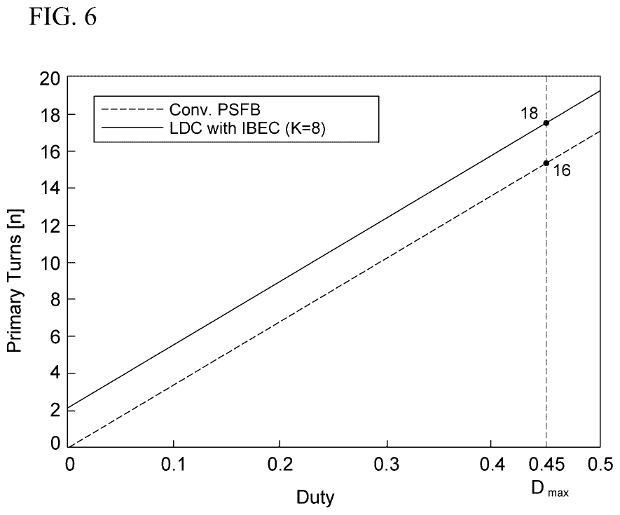

FIG. 5 is a diagram illustrating voltage gains of the power conversion device according to the embodiment of the present disclosure and an existing one, and FIG. 6 is a diagram illustrating a maximum duty depending on turn ratio of the transformer in the conversion circuit according to an embodiment of the present disclosure.

The voltage gain of the power conversion device according to the embodiment of the present disclosure increases by ½K compared to the voltage gain of the existing PSFB converter, as shown in Equation 1 below.

$$G = 2 \cdot \frac{1}{n} ( D + \frac{1}{2 K} ) \qquad [ Equation 1 ]$$

Here, n represents turn ratio of the conversion circuit, and K represents the number of modules in the high voltage battery.

First, referring to FIG. 5, it can be confirmed that a voltage gain of the power conversion device (an LDC with IBEC) according to an embodiment of the present disclosure is higher than that of the existing PSFB converter (Conv. PSFB) in all cases where the turn ratio of the conversion circuit is 4, 6, and 8. It can also be confirmed that, since the voltage of each battery module becomes higher as the number K of battery modules in the high voltage battery decreases, a higher additional voltage is applied to the primary side and thus the voltage gain increases.

In FIG. 6, a relationship between primary turn ratio n and a maximum duty Dₘₐₓ when turn ratio of the transformer in the conversion circuit is n:1 is shown. Referring to FIG. 6, it can be seen that, when the power conversion device according to the embodiment of the present disclosure and the existing PSFB converter are designed to have the same maximum duty, primary turn ratio of the power conversion device according to the embodiment of the present disclosure can be designed to be larger. Therefore, since the primary-side current is reduced, a conduction loss can be reduced. In fact, when the maximum duty is designed to be 0.45, it can be confirmed that the existing PSFB converter has primary turns of 18, but the power conversion device according to the embodiment of the present disclosure can have turns of 16 under the same design conditions.

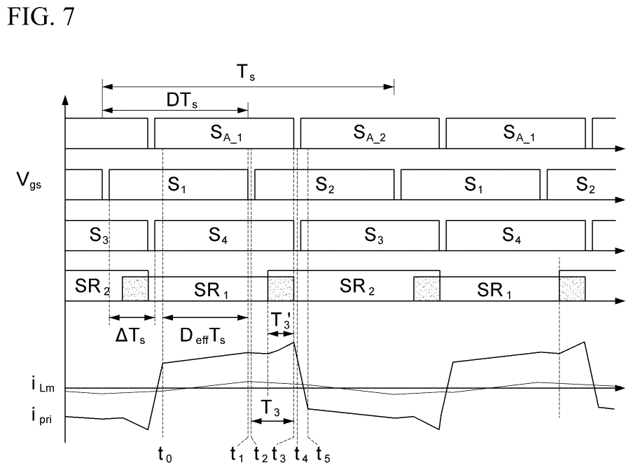

FIG. 7 is a diagram illustrating a method of applying a gate signal to the synchronous rectifiers according to an embodiment of the present disclosure.

Referring to FIG. 7, gate signals S₁ to S₄ for the PSFB converter can be applied in the same manner as an existing PSFB. Gate signals S_{A_1} and S_{A_2} for the IBEC can be applied exclusively to each other.

In the case of the discharging mode, a gate signal for S_{A_1} and a gate signal for S₄ can be synchronized. In the case of the charging mode, a gate signal for S_{A_2} and the gate signal for S₄ can be synchronized.

A ZVS condition of the lagging leg switch and the IBEC switch of the conversion circuit in the power conversion device according to the embodiment of the present disclosure can be expressed as Equation 2 below.

$$\frac{1}{2} {C}_{OSS 3 , 4} {{V}_{HVBatt}}^{2} \cdot 2 \leq \frac{1}{2} ( {L}_{lkg} + {m}^{2} {L}_{lkg \_ A} ) {{i}_{pri} ( {t}_{3} )}^{2} \qquad [ Equation 2 ]$$

$$\frac{1}{2} {C}_{OSSA \_ 1 , 2} {{V}_{MK}}^{2} \cdot 2 \leq \frac{1}{2} ( \frac{1}{{m}^{2}} {L}_{lkg} + {L}_{lkg \_ A} ) {( {mi}_{pri} ( {t}_{3} ) )}^{2}$$

Here, since a voltage of the high voltage battery is very high, the ZVS of the IBEC switch is also naturally achieved when the ZVS condition of the lagging leg switch is achieved.

However, under the small load condition, the primary-side current decreases, making it impossible to guarantee the ZVS condition. To solve this problem, the gate signals SR₁ and SR₂ for the secondary-side synchronous rectifiers can be applied in an overlapping manner in a t₃′ section, as in FIG. 7.

In the t₃′ section, the primary-side current increases with a steep slope because a secondary side transformer voltage v_{eq} of the IBEC is applied to the leakage inductors. Therefore, when gate signals for SR₁ and SR₂ are applied in an overlapping manner in the t₃′ section, the primary-side current is forcibly built up so that a sufficient ZVS current can be secured. The t₃′ section may be calculated based on a current amount required for ZVS, as shown in Equation 3 below.

$${i}_{Pri} ( {t}_{3} ) = {i}_{Pri} ( {t}_{2} ) + \frac{{v}_{Eq}}{{L}_{O}} ( {T}_{3} - {{t}_{3}}^{′} ) + \frac{{v}_{Eq}}{{L}_{lkg}} ( {{t}_{3}}^{′} ) \qquad [ Equation 3 ]$$

t₃′ can be calculated as Equation 4 below based on Equations 2 and 3.

$$\sqrt{\frac{2 {C}_{OSS 3 , 4} {{V}_{HVBatt}}^{2}}{{L}_{lkg} + {m}^{2} {L}_{lkg \_ A}}} \leq {i}_{Pri} ( {t}_{2} ) + {v}_{Eq} {{t}_{3}}^{′} ( \frac{1}{{L}_{lkg}} - \frac{1}{{L}_{O}} ) + \frac{{v}_{Eq}}{{L}_{O}} {T}_{3} \qquad [ Equation 4 ]$$

Thus, since the power conversion device according to the embodiment of the present disclosure operates to increase a leakage inductor current using the balancing energy of the battery module, both a primary-side switch and the IBEC switch can achieve ZVS, so that an efficiency increase effect through s reduced switching loss can be expected.

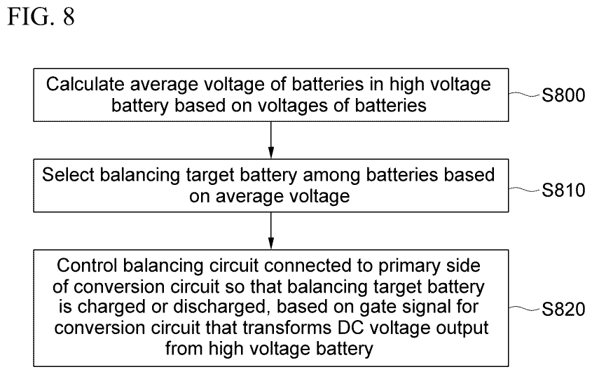

FIG. 8 is a diagram illustrating a battery balancing method according to an embodiment of the present disclosure.

Referring to FIG. 8, the controller included in the power system may monitor the voltages of the batteries in the high voltage battery and calculate the average voltage of the batteries based on the voltages of the batteries (S800). In this case, the controller may monitor the voltage of the high voltage battery and the voltage of the low voltage battery, and determine whether the voltage of the low voltage battery corresponds to a voltage in a fully charged state.

When the low voltage battery is not in the fully charged state, the controller may select the balancing target battery among the batteries based on the average voltage of the batteries (S810). To this end, as an example, the controller may calculate a difference between the average voltage of the batteries in the high voltage battery and the voltage of each battery. The controller may select the battery having the largest voltage difference from the average voltage among the batteries in the high voltage battery as the balancing target battery. In this case, when the difference value is smaller than a preset balancing start threshold value for all the batteries, the controller may not perform the inter-module balancing.

Meanwhile, the controller can derive the number of batteries having the voltage lower than the average voltage in the high voltage battery. When the number of batteries having the voltage lower than the average voltage is equal to or smaller than the preset number, the controller can check whether the voltage of the high voltage battery is within a preset voltage range. Here, the preset voltage range may mean a voltage range in which the power conversion device can operate in the charging mode.

When the number of batteries having the voltage lower than the average voltage is equal to or smaller than the preset number and the power conversion device can operate in the charging mode, the controller may perform control so that the balancing target battery is charged. However, when the number of batteries having the voltage lower than the average voltage is larger than the preset number, the controller may perform control so that the balancing target battery is discharged.

To this end, the controller may control the balancing circuit connected to the primary side of the conversion circuit so that the balancing target battery is charged or discharged, based on the gate signal for the conversion circuit that transforms a DC voltage output from the high voltage battery (S820). For example, when the conversion circuit is implemented as a PSFB converter, the controller can control driving of the switches in the balancing circuit based on the gate signal for the lagging leg switches of the PSFB.

In the case of the discharging mode, the controller may synchronize the gate signal for the first switch (upper switch S_{A_1}) in the balancing circuit with the gate signal for the second lagging leg switch (lower lagging leg switch S₄) of the PSFB.

In the charging mode, the controller may synchronize the gate signal for the first switch (upper switch S_{A_1}) among the switches in the balancing circuit with the gate signal for the first lagging leg switch (upper lagging leg switch S₃) of the PSFB.

Meanwhile, the controller may perform control so that the gate signal applied to the first synchronous rectifier included in the secondary side of the conversion circuit and the gate signal applied to the second synchronous rectifier overlap during a preset period of time.

Therefore, the power conversion device according to the embodiment of the present disclosure can perform a bidirectional balancing operation for charging and discharging, and at the same time, can also perform a role of an LDC that converts the voltage of the high voltage battery into a voltage for the low voltage battery. Further, the power conversion device according to the embodiment of the present disclosure can be implemented by adding only a small number of components to an existing converter. Further, since an additional powering operation is possible in the discharging mode, a gain can be improved and the primary-side current can be reduced so that the conduction loss can be reduced and the efficiency can be improved. Further, the power conversion device according to the embodiment of the present disclosure has advantages in that it is possible to drive the IEBC using the gate signals of the lagging leg switches of the PSFB converter, and the control is simple since the duty is fixed to 0.5. Further, since the gate signals are applied to the secondary-side synchronous rectifiers so that the gate signals overlap for a certain period of time, the switching loss can be reduced, and the efficiency at a low load can also be improved.

Combinations of individual steps of the appended flow diagrams of the present disclosure may be performed by computer program instructions. Since these computer program instructions may be provided to a processor of a general-purpose computer, a special-purpose computer, or other programmable data processing apparatus, the instructions executed through the processor of the computer or other programmable data processing apparatus generate means for implementing the functions specified in the individual steps of the flow diagrams. Since these computer program instructions may also be stored in a computer-usable or computer-readable memory that may be directed to a computer or other programmable data processing apparatus to implement a function in a particular manner, the instructions stored in the computer-usable or computer-readable memory may produce a manufacturing item including instructions that execute the functions specified in the individual steps of the flow diagrams. Since the computer program instructions may also be loaded onto a computer or other programmable data processing apparatus, by performing a series of operational steps on the computer or other programmable data processing apparatus to generate a process executed by the computer, the instructions operating the computer or other programmable data processing apparatus may also provide steps for executing the functions specified in the respective steps of the flow diagrams.

Also, each step may represent part of a module, segment, or code including one or more executable instructions for executing a specific logical function(s). Also, it is also possible that in some alternative embodiments, the specified functions are executed out of specified order. For example, it is possible that two steps shown one after another may be performed simultaneously, or the steps may be performed in reverse order depending on the corresponding functions.

The above description is merely exemplary description of the technical scope of the present disclosure, and it should be understood by those skilled in the art that various changes and modifications may be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims, and it should be appreciated that all technical scopes included within a range equivalent thereto are included in the protection scope of the present disclosure.

### DETAILED DESCRIPTION OF MAIN ELEMENTS

200: Power conversion device
201: Conversion circuit
202: Balancing circuit
210: High voltage battery
220: Low voltage battery
230: Switching circuit

What is claimed is:

1. A power conversion device included in a power system, comprising:
a conversion circuit configured to transform a direct current (DC) voltage output from batteries; and
a balancing circuit connected to a primary side of the conversion circuit and configured to balance states of charge of the batteries,
wherein the balancing circuit performs driving so that a balancing target battery among the batteries is charged or discharged based on a gate signal for the conversion circuit, and
wherein the balancing target battery is connected to the balancing circuit based on an average voltage of the batteries.

2. The power conversion device of claim 1, wherein the balancing circuit includes
a transformer having preset turn ratio;
switches driven based on the gate signal for the conversion circuit; and
a DC blocking capacitor included between the switches and the transformer.

3. The power conversion device of claim 2, wherein the conversion circuit includes a phase shift full bridge, and the switches are driven based on gate signals for lagging leg switches of the phase shift full bridge.

4. The power conversion device of claim 3, wherein the balancing circuit charges the balancing target battery based on synchronization between a gate signal for a first switch among the switches and a gate signal for a first lagging leg switch of the phase shift full bridge, and the balancing circuit discharges the balancing target battery based on synchronization between the gate signal for the first switch and a gate signal for a second lagging leg switch of the phase shift full bridge.

5. The power conversion device of claim 4, wherein the balancing circuit charges the balancing target battery based on the number of batteries having a voltage lower than the average voltage among the batteries being equal to or smaller than a preset number.

6. The power conversion device of claim 5, wherein the balancing circuit charges the balancing target battery based on the voltages of the batteries being within a preset voltage range.

7. The power conversion device of claim 1, wherein a gate signal applied to a first synchronous rectifier included in a secondary side of the conversion circuit and a gate signal applied to a second synchronous rectifier included in the secondary side of the conversion circuit overlap during a preset period of time.

8. A method of balancing states of charge of batteries in a controller of a power system, the method comprising:
monitoring voltages of the batteries and calculating an average voltage of the batteries based on the voltages of the batteries;
selecting a balancing target battery among the batteries based on the average voltage of the batteries; and
controlling a balancing circuit connected to a primary side of a conversion circuit so that the balancing target battery is charged or discharged, based on a gate signal for the conversion circuit configured to transform a direct current (DC) voltage output from the batteries.

9. The method of claim 8, wherein the balancing circuit includes
a transformer having preset turn ratio;
switches driven based on the gate signal for the conversion circuit; and
a DC blocking capacitor included between the switches and the transformer.

10. The method of claim 9, wherein the conversion circuit includes a phase shift full bridge, and
wherein the controlling includes controlling driving of the switches based on gate signals for lagging leg switches of the phase shift full bridge.

11. The method of claim 10, wherein the controlling includes
performing control to synchronize a gate signal for a first switch among the switches with a gate signal for a first lagging leg switch of the phase shift full bridge so that the balancing target battery is charged; and
performing control to synchronize the gate signal for the first switch with a gate signal for a second lagging leg switch of the phase shift full bridge so that the balancing target battery is discharged.

12. The method of claim 10, wherein the selecting includes selecting the battery having a voltage with the largest difference from the average voltage among the batteries as the balancing target battery.

13. The method of claim 12, wherein the controlling includes performing control so that the balancing target battery is charged based on the number of batteries having a voltage lower than the average voltage among the batteries being equal to or smaller than a preset number.

14. The method of claim 8, wherein the controlling includes performing control so that a gate signal applied to a first synchronous rectifier included in a secondary side of the conversion circuit and a gate signal applied to a second synchronous rectifier included in the secondary side of the conversion circuit overlap during a preset period of time.

15. A power system comprising:
a plurality of batteries;
a DC-DC converter including a conversion circuit configured to transform a direct current (DC) voltage output from the plurality of batteries, and a balancing circuit connected to a primary side of the conversion circuit and configured to balance states of charge of the batteries;
a switching circuit included between the batteries and the balancing circuit and configured to connect a balancing target battery among the batteries to the balancing circuit; and
a controller configured to monitor the voltages of the batteries to calculate an average voltage of the batteries, control the switching circuit so that the balancing target battery is connected to the balancing circuit based on the average voltage, and control the balancing circuit so that the balancing target battery is charged or discharged based on a gate signal for the conversion circuit.
